(19) United States
(12) Patent Application Publication
(10) Pub. No.: US 2010/0048393 A1
(43) Pub. Date: Feb. 25, 2010

(54) Solid Particle Controlled Dispersing Nozzle and Process

(75) Inventor: Martin Juarez-Zamacona, Tega Cay, SC (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: BASF SE, Ludwigshafen (DE)

(21) Appl. No.: 12/514,971

(22) PCT Filed: Dec. 3, 2007
(86) PCT No.: PCT/EP2007/063149

§ 371 Date: May 14, 2009

Related U.S. Application Data
(60) Provisional application No. 60/872,942, filed on Dec. 5, 2006.

(51) Int. Cl. B01J 20/26; B05B 7/06

(52) U.S. Cl. 502/402; 118/311

(57) ABSTRACT

A two-component nozzle (200) for the pneumatic delivery of solid particulates is disclosed. The nozzle generally includes an inner conduit (210) for conveying solid particulates such as superabsorbent polymer particles and an outer conduit (220) for conveying an outer airflow that is directed via a foraminous plate (300) into the path of the solid particulates exiting the nozzle. The outer airflow improves the weight distribution of the solid particulates as they are deposited onto a substrate to form a composite material. The nozzle (200) can optionally deliver other components such as fluff, binders, and water in addition to the solid particulates. A production process for the composite material, suitable for inclusion in an absorbent articles, also is disclosed.

### FIELD OF THE DISCLOSURE

The disclosure relates to a two-component nozzle for the pneumatic delivery of solid particulates, such as superabsorbent polymer (SAP) particles. More particularly, the disclosure relates to a two-component nozzle capable of applying solid particulates to a substrate (e.g., a nonwoven substrate) such that the solid particulates have an improved weight distribution on the substrate. A process for the homogeneous application of solid particulates to a substrate is also disclosed.

### BRIEF DESCRIPTION OF RELATED TECHNOLOGY

In a typical air-laying process, SAP particles are applied to a substrate to form an absorbent core for absorbent articles such as diapers and feminine hygiene products. Conventional SAP application systems lack the ability to apply the SAP particles uniformly (i.e., in a controlled manner) to the substrate.

The non-uniform distribution of the applied SAP particles on the substrate is undesirable. Products so formed have a correspondingly variable composition, and the fraction of products that are rejected for being outside of quality control specifications increases. The weight distribution deviation in such products can be as high as 40% relative to the desired mean distribution. The inability to control the application of the SAP particles also results in other process inefficiencies, such as a loss of SAP material around the forming machine, an increased amount of SAP that must be recycled through the various screens of the forming machine, thereby degrading the process performance properties and reducing the lifespan of the various filtering media in the forming machine.

### SUMMARY

Accordingly, it is desirable to improve the uniformity of solid particulates (e.g., SAP particles) applied to a substrate when forming a particulate-substrate composite material (e.g., for use in an absorbent article such as a diaper or a feminine hygiene product). When the particulate-substrate composite material is incorporated into a product, the product uniformity is correspondingly increased and production process inefficiencies are simultaneously reduced.

One aspect of the disclosure provides a two-component nozzle for the pneumatic delivery of solid particulates, including an inner conduit including an inner wall, an inner exit plane defined by the inner wall, and an inner flow region defined as the space encompassed by the inner wall; an outer conduit surrounding the inner conduit, the outer conduit including an outer wall, an outer exit plane defined by the outer wall, and an outer flow region defined as the space between the inner wall and the outer wall; and, a foraminous plate including an inner edge, an outer edge, and a plurality of orifices, wherein the outer edge is attached to the outer wall at the outer exit plane, the inner edge is attached to the inner wall at the inner exit plane. The two-component nozzle is capable of applying solid particulates exiting the inner flow region to a substrate such that the solid particulates have a linear weight distribution deviation of less than about 15%. In a further embodiment, the two-component nozzle is capable of applying solid particulates exiting the inner flow region to a substrate such that the solid particulates have an areal weight distribution deviation of less than about 15%.

Another aspect of the disclosure provides a two-component nozzle for the pneumatic delivery of solid particulates, including: an inner conduit including an inner wall, an inner exit plane defined by the inner wall, and an inner flow region defined as the space encompassed by the inner wall; an outer conduit surrounding the inner conduit, the outer conduit including an outer wall, an outer exit plane defined by the outer wall, and an outer flow region defined as the space between the inner wall and the outer wall; and, a foraminous plate including an inner edge, an outer edge, and a plurality of orifices, wherein the outer edge is attached to the outer wall at the outer exit plane, the inner edge is attached to the inner wall at the inner exit plane. In the two-component nozzle, the foraminous plate and the outer wall define a contact angle; each orifice has an axis defining an orifice angle with the foraminous plate; the contact angle is less than 90°; and, the sum of the contact angle and the orifice angle is less than 180°.

Another aspect of the disclosure provides a process for the homogeneous application of solid particulates to a substrate, including the step of providing a two-component nozzle including: an inner conduit including an inner wall, an inner exit plane defined by the inner wall, and an inner flow region defined as the space encompassed by the inner wall; an outer conduit surrounding the inner conduit, the outer conduit including an outer wall, an outer exit plane defined by the outer wall, and an outer flow region defined as the space between the inner wall and the outer wall; and, a foraminous plate including an inner edge, an outer edge, and a plurality of orifices, wherein the outer edge is attached to the outer wall at the outer exit plane, the inner edge is attached to the inner wall at the inner exit plane, and the foraminous plate and the outer exit plane define a contact angle less than 90°. The process also includes the steps of: pneumatically feeding solid particulates to the inner flow region; supplying an airflow to the outer flow region; mixing the solid particulates exiting the two-component nozzle from the inner flow region with the airflow exiting the two-component nozzle from the outer flow region, thereby forming a mixed particulate stream; and, applying the mixed particulate stream to a substrate, thereby forming a particulate-substrate composite material.

Further aspects and advantages will be apparent to those of ordinary skill in the art from a review of the following detailed description. While the compositions and articles are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

Objects, features, and advantages of the present disclosure will become apparent upon reading the following description in conjunction with the drawing figures, in which:

FIG. 1A is a side sectional view of a conducting pipe.

FIG. 1B presents time-dependent solid particulate distributions at the exit plane of the conducting pipe of FIG. 1A.

FIG. 1C is a perspective view of a particulate-substrate composite material produced with the conducting pipe of FIG. 1A.

FIG. 2A is a side sectional view of a two-component nozzle according to an embodiment of the present disclosure.

FIG. 2B presents solid particulate distributions downstream of the exit plane of the two-component nozzle of FIG. 2A.

FIG. 3A is a front view of a foraminous plate according to an embodiment of the two-component nozzle of FIG. 2A.

FIG. 3B is a perspective view of the foraminous plate of FIG. 3A.

FIG. 3C is a side sectional view of the foraminous plate of FIG. 3A in an embodiment having cylindrical orifices.

FIG. 3D is a side sectional view of the foraminous plate of FIG. 3A in an embodiment having frustoconical orifices.

FIG. 3E is a side sectional view of the foraminous plate of FIG. 3A in an embodiment having a perpendicular outer plate and angled orifices.

FIG. 4A is a side sectional view of the two-component nozzle of FIG. 2A and a substrate in a process for the homogeneous application of solid particulates to the substrate.

FIG. 4B is a perspective view of a particulate-substrate composite material produced according to the process of FIG. 4A.

FIG. 5 is a schematic of the overall process for the homogeneous application of solid particulates to a substrate using the two-component nozzle of FIG. 2A.

FIG. 6A is a top view of a sample for measuring the linear weight distribution deviation in the particulate-substrate composite material of FIG. 4B.

FIG. 6B is a top view of a sample for measuring the areal weight distribution deviation in the particulate-substrate composite material of FIG. 4B.

### DETAILED DESCRIPTION

Nozzles for the application of solid particulates to a substrate are disclosed. A two-component nozzle for improving the uniformity of solid particulates applied to a substrate when forming a particulate-substrate composite material is also disclosed. As used herein, the term “two-component” nozzle refers to a single nozzle having at least two segregated air streams that can contain solid particulates and optional additives such as fluff, binders, steam and/or water. The at least two air streams are segregated up to the point at which they exit the two-component nozzle, whereupon the streams combine to form a mixed particulate stream. The mixed particulate stream has an improved distribution uniformity of solid particulates in the plane perpendicular to the mixed particulate stream flow direction. Thus, when the mixed particulate stream is applied to a substrate to form a particulate-substrate composite material, the deviation of the applied weight distribution of solid particles relative to the target, average weight distribution is improved.

### One-Component Nozzle

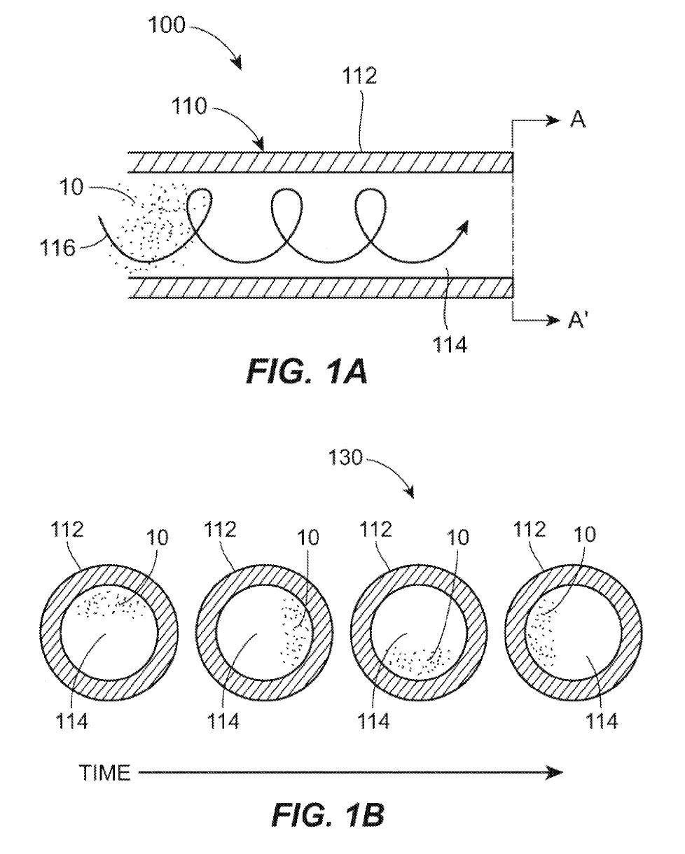

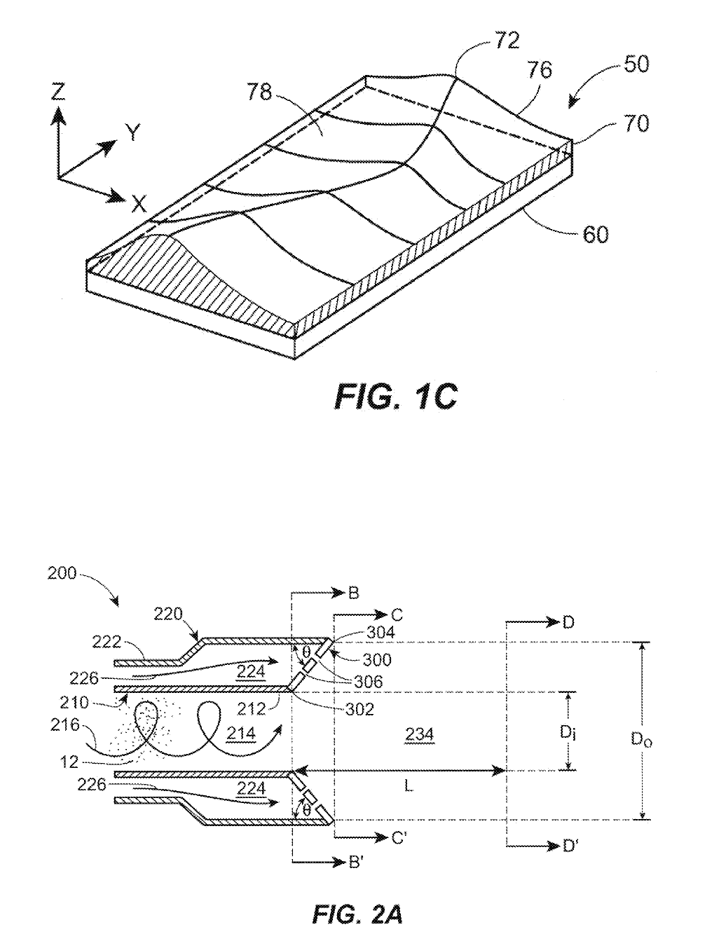

FIG. 1A shows a conducting pipe or one-component nozzle 100 for the application of SAP particles 10. The nozzle 100 generally includes a conduit 110 having a cylindrical cross section. The conduit 110 has a wall 112 that encompasses a flow region 114. When the SAP particles 10 are pneumatically transported through the nozzle 100, a non-uniform airflow 116 typically develops within the flow region 114. As illustrated in FIG. 1A, the non-uniform airflow 116 has a substantially helical shape, although other non-uniformities (whether spatially dependent, time-dependent, or both) may be encountered.

The effect of the non-uniform airflow 116 on the SAP particles 10 is illustrated in FIG. 1B. FIG. 1A shows an exit plane A-A′ of the conduit 110, which exit plane A-A′ is defined by the wall 112 as illustrated. FIG. 1B shows the time-dependent nature of an exit-plane particulate distribution 130 resulting from the illustrated helical non-uniform airflow 116. Because of the density difference between the SAP particles 10 and the conveying air, centrifugal forces induced by the non-uniform airflow 116 tend to segregate the SAP particles 10 within the flow region 114. When the SAP particles 10 reach the exit plane A-A′, they tend to be non-uniformly distributed across the cross-section of the conduit 110. FIG. 1B illustrates this non-uniform distribution at the exit plane A-A′ as a function of time. Because of the unsteady nature of the non-uniform airflow 116, the location in the exit plane A-A′ in which the SAP particles 10 tend to be preferentially located is also time-dependent.

The effect of the non-uniform airflow 116 on a particle-substrate composite 50 (e.g., for use in an absorbent article) is illustrated in FIG. 1C. Ultimately, when the SAP particles 10 are applied to a substrate 60 located on a forming surface in a forming chamber, a deposited particulate layer 70 is non-uniform. For example, if the nozzle 100 is used to apply the SAP particles 10 to the substrate 60 when the substrate 60 is moving relative to the nozzle 100 in the y-direction, the non-uniform distribution illustrated in FIG. 1B results in the deposited particulate layer 70 having a local maximum thickness 72 (i.e., in the z-direction) that varies in both directions coplanar with the substrate 60 (i.e., in the x- and y-directions or, equivalently, in the cross- and machine-directions).

### Two-Component Nozzle

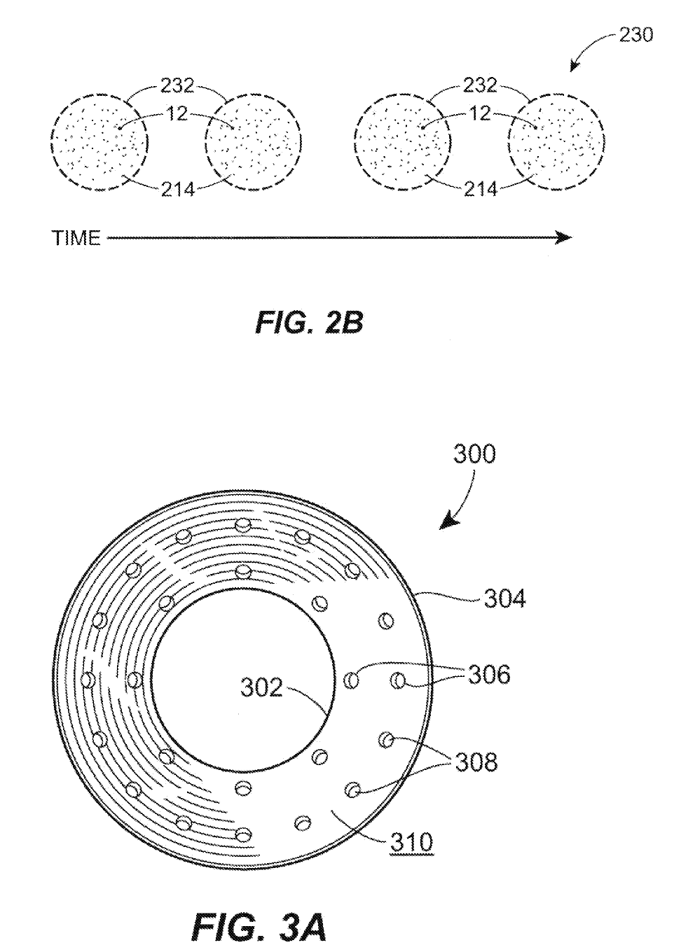

FIGS. 2A and 2B illustrate a two-component nozzle 200 according to the present disclosure. The two-component nozzle 200 generally includes an inner conduit 210, an outer conduit 220, and a foraminous plate 300, each of which is generally formed from stainless steel or other abrasion-resistant metals.

The inner conduit 210 includes an inner wall 212 having a generally cylindrical cross section in the plane perpendicular to its axis. The inner conduit 210 also includes an inner flow region 214 defined as the space encompassed by the inner wall 212. When solid particulates 12 are pneumatically transported through the inner conduit 210, a non-uniform inner airflow 216 typically develops within the flow region 214. The inner wall 212 also defines an exit plane B-B′ at the location where the inner airflow 216 and its pneumatically transported contents exit the inner conduit 210. The effect of the non-uniform inner airflow 216 on the solid particulates 12 is substantially the same as illustrated in FIG. 1B (i.e., the solid particulates 12 are generally expected to have a time-dependent, non-uniform distribution across the exit plane B-B′ as they exit the inner conduit 210).

The outer conduit 220 surrounds, either partially or completely, the inner conduit 210 and includes an outer wall 222 having a generally cylindrical cross section in the plane perpendicular to its axis. The inner and outer conduits 210, 220 can be formed from a single unitary structure, or they can be two separate structures held in place relative to each other with, for example, tangentially distributed structures (not shown) between the inner and outer walls 212, 222, including structures such as flanges, vanes, posts, and the like. The outer conduit 220 includes an outer flow region 224 defined as the space between the inner wall 212 and the outer wall 222. In operation, an outer airflow 226 is generated to improve the uniformity of solid particulates 12 exiting the inner conduit 210. The outer wall 222 also defines an exit plane C-C′ at the farthest extent of the outer wall 222 in the direction of the outer airflow 226.

In the embodiment shown in FIG. 2A, the outer airflow 226 undergoes an expansion in the outer flow region 224 just prior to exiting the two-component nozzle 200. The expansion creates a buffer upstream of the exit of the two-component nozzle 200, thereby permitting pressure accumulation in the buffer that can compensate for random sudden losses of pressure in the outer conduit 220. At the same time, the corresponding expansion of the outer wall 222 provides an additional aerodynamic effect on a flow of fibers (e.g., fluff fibers; not shown) that can be exterior to the two-component nozzle 200 in some embodiments. The expanding outer wall 222 diverts the exterior flow of fibers in the neighborhood of the two-component nozzle 200, limiting the ability of the fibers to disturb the flow of the solid particulates 12 exiting the two-component nozzle 200.

In the illustrated embodiment, the inner and outer conduits 210, 220 have circular cross sections with inner and outer diameters Dᵢ and Dₒ (respectively), wherein the outer diameter Dₒ is larger than the inner diameter Dᵢ. The inner diameter Dᵢ generally ranges from about 20 mm to about 200 mm, for example about 50 mm, and the outer diameter Dₒ generally ranges from about 35 mm to about 380 mm, for example about 95 mm. The particular choice of diameters largely depends on the desired throughput in a particular application. In the illustrated embodiment, the inner and outer conduits 210, 220 are aligned such that the outer flow region 224 has a substantially annular cross section. However, the inner and outer conduits 210, 220 are not limited to substantially circular cross sections. For example, inner and outer conduits 210, 220 can be coaxial ducts having rectangular or elliptical cross sections.

The outer conduit 220 generally completely surrounds the inner conduit 210. In another embodiment (not shown), the outer conduit 220 only partially surrounds the inner conduit 210. In such an embodiment, it is preferable to have multiple outer conduits that partially surround and that are circumferentially distributed around the inner conduit 210. For example, the two-component nozzle 200 can have four outer conduits circumferentially distributed around the inner conduit 210 at 90° intervals, each of which outer conduits spans 45° of the circumference of inner conduit 210 (i.e., each outer conduit partially surrounds the inner conduit). In this embodiment, the airflow rates through each individual outer conduit can be independently selected to provide more control over the effluent stream (e.g., including the inner airflow 216 and the solid particulates 12) of the inner conduit 210.

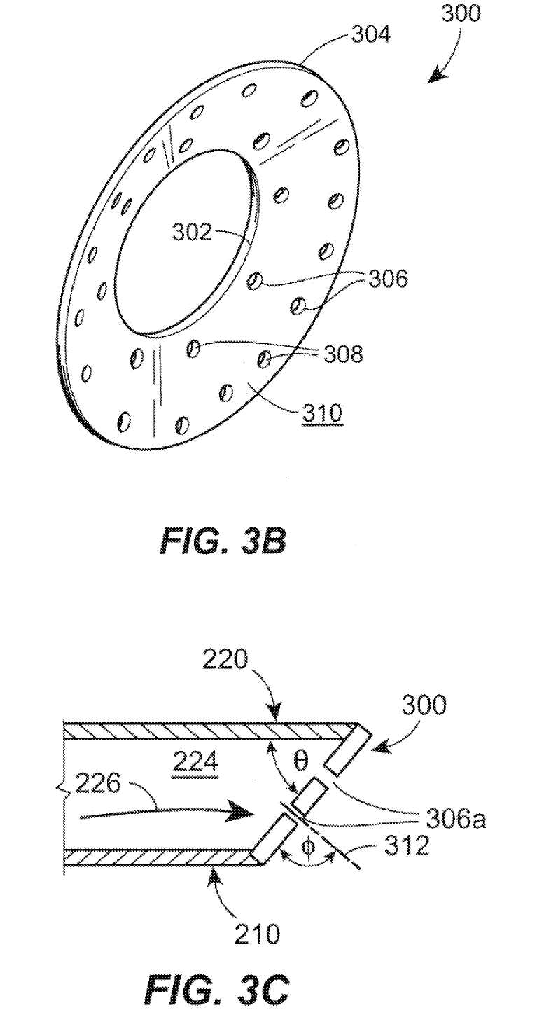

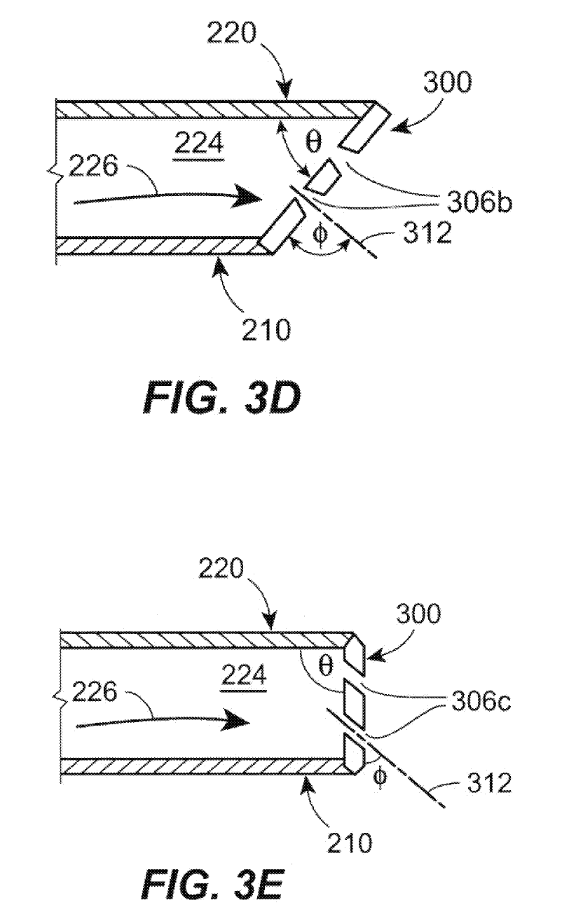

FIGS. 3A-3E illustrate the foraminous plate 300 for use with the disclosed two-component nozzle 200. The foraminous plate 300 generally has a frustoconical shape (see FIG. 3B) with an annular projection (see FIG. 3A) complementary to the cross section of the outer flow region 224. The foraminous plate 300 has an inner edge 302, an outer edge 304, a plurality of orifices 306, and a surface area 310. The surface area 310 is the solid surface area on one side of the foraminous plate between the inner and outer edges 302, 304. Each orifice has a surface area 308 representing the area available for flow from the outer flow region 224 into a free stream region 234. The foraminous plate 300 is incorporated into the two-component nozzle such that the outer edge 304 is attached to the outer wall 222 at the outer exit plane C-C′ and the inner edge 302 is attached to the inner wall 212 at the inner exit plane B-B′.

The attachment of the foraminous plate 300 to the outer wall 222 defines a contact angle θ as illustrated in FIGS. 2A and 3C-3E. The contact angle θ is preferably less than 90°, more preferably in a range of about 5° to about 75°, most preferably in a range of about 30° to about 70°, for example about 60°. Contact angles θ less than 90° help generate converging streams causing the outer airflow 226 to mix with the inner airflow 216, once the two airflows enter the free stream region 234. The mixing of the inner and outer airflows 216, 226 in a converging fashion is believed both to improve the uniformity of the solid particulates 12 and to improve the mixing of additives in the outer airflow 226 (e.g., binders, steam, and/or water) with the solid particulates 12 (and, optionally, fluff fibers and/or solid binders) entering the free stream region 234.

The geometric details of the foraminous plate 300 can be selected in view of a specific delivery application. The shape of the orifices 306 is not particularly limited, and suitable shapes include cylindrical (e.g., circular, elliptic), frustoconical (e.g., expanding, converging), helicoidal (e.g., a rifled channel), tri-lobal, and irregular shapes, as well as combinations of the foregoing. When the outer airflow 226 contains only low-viscosity fluids (e.g., air, water), expanding frustoconical orifices 306b are preferred. As shown in FIG. 3D, the frustoconical shape expands in the direction of the outer airflow 226 or, alternatively, in a direction generally from the inner exit plane B-B′ to the outer exit plane C-C′. When the outer airflow 226 contains high-viscosity fluids (e.g., a liquid binder resin), cylindrical orifices 306a are preferred, as shown in FIG. 3C. When the outer airflow 226 contains solids (e.g., solid binder particles), the diameter of the orifices 306 can be increased. Other shapes can be selected to induce other flow characteristics of the outer airflow 226 exiting the orifices 306 (e.g., helicoidal and tri-lobal shapes that induce swirling flows, converging frustoconical shapes that reduce the outer airflow 226 temperature).

The diameter of the orifices 306 and the plurality of surface areas 308 permit independent control of the pressure drop, volumetric flow rate, and velocity of the outer airflow 226 passing through the orifices 306. For example, adjusting the velocity of the outer airflow 226 can be useful in limiting the spread of the inner airflow 216 as it enters the free stream region 234. Similarly, adjusting the volumetric flow rate of the outer airflow 226 can control the rate at which additives in the outer airflow 226 stream (e.g., water, binder) are mixed with the solid particulates 12, which rate of addition may be selected in view of the flow rate, size, and shape of the solid particulates 12 (and, optionally, fluff fibers), the speed of a downstream converting machine, and/or the environmental conditions (e.g., relative humidity and temperature) of the process. For example, higher flow rates of solid particulates 12 and size/shape distributions of solid particulates 12 having large surface area-to-volume ratios can require a higher rate of addition of a binder additive from the outer airflow 226. The orifices 306 generally have a diameter in a range of about 1 mm to about 5 mm, or about 2 mm to about 4 mm, for example about 3 mm. The plurality of surface areas 308 of the orifices 306 relative to the surface area 310 of the foraminous plate 300 is generally in a range of about 0.01 to about 0.1, or about 0.02 to about 0.05. This relative surface area ratio can be adjusted to accommodate varying flow rates of process materials by varying the number and/or the diameter of the orifices 306.

Each orifice 306 has an axis 312 that defines an orifice angle φ between the axis 312 and the foraminous plate 300. As illustrated in FIGS. 3C and 3D, the orifice angle φ is 90°, while the orifice angle φ illustrated in FIG. 3E (by angled orifices 306c) is less than 90° Orifice angles φ less than 90° can be selected in addition to or in place of contact angles θ less than 90°. Preferably, the sum θ+φ is less than 180°, and the two-component nozzle 200 still generates converging streams causing the outer airflow 226 to mix with the inner airflow 216, once the two airflows enter the free stream region 234. The sum θ+φ is more preferably in a range of about 95° to about 165°, most preferably in a range of about 120° to about 160°, for example about 150°.

The foraminous plate 300 can be formed from a single unitary structure with either or both of the inner and outer conduits 210, 220. However, in an embodiment, the foraminous plate 300 is a separate structure that can be removably attached to the inner and outer conduits 210, 220. This embodiment allows the performance of the two-component nozzle 200 to be tailored to a specific delivery application by selecting from foraminous plates 300 having variable geometries (e.g., orifice shape, orifice diameter, orifice angle, orifice surface area). An example of this embodiment (not shown) includes a configuration in which the foraminous plate 300 is attached to a threaded cylindrical sleeve (not shown) that attaches to corresponding threads (not shown) on the outer surface of the outer wall 222.

### Process Materials

The solid particulates 12 of the present disclosure can be any solid material that is desirably pneumatically applied to a surface in a uniformly distributed manner. The solid particulates 12 preferably include SAP particles, which SAP particles are useful in absorbing liquid material when the particulate-substrate composite 50 is included in an absorbent article (e.g., as an absorbent core) such as a disposable diaper. The particles can have any desired shape such as, for example, cubic, rod-like (e.g., fibers), polyhedral, spherical or semispherical (e.g., granules), rounded or semi-rounded (e.g., droplet-shaped, with or without an internal void), plate-like (e.g., flakes), angular, irregular, and the like. SAP particles generally have particle sizes ranging from about 150 μm to about 850 μm, although particles as small as about 45 μm can also be present. The weight-average particle size for the SAP particles is generally in the range of about 300 μm to about 550 μm. When SAP particles having a non-spherical or non-semispherical shape are used, the particle sizes are such that the smaller particles in the distribution have a volume equivalent to a sphere of about 150 μm and the larger particles in the distribution have a volume equivalent to a sphere of about 850 μm.

The SAP particles are generally formed from a lightly crosslinked polymer capable of absorbing several times its own weight in water and/or saline. SAP particles can be made by conventional processes for preparing SAPs, which processes are well known in the art and include, for example, solution polymerization and inverse suspension polymerization. SAP particles useful in the present invention are prepared from one or more monoethylenically unsaturated compounds having at least one acid moiety, such as carboxyl, carboxylic acid anhydride, carboxylic acid salt, sulfonic acid, sulfonic acid salt, sulfuric acid, sulfuric acid salt, phosphoric acid, phosphoric acid salt, phosphonic acid, or phosphonic acid salt. Suitable monomers include acrylic acid, methacrylic acid, malcic acid, fumaric acid, maleic anhydride, and the sodium, potassium, and ammonium salts thereof Especially preferred monomers include acrylic acid and its sodium salt.

The flow rate of solid particulates 12 delivered by the two-component nozzle 200 is not particularly limited, and is generally determined according to the desired ratio between the fluff (if present) and solid particulates 12 in the final particulate-substrate composite 50 and/or downstream processing equipment limitations. The flow rate is preferably in a range of about 0.25 kg/min to about 25 kg/min, more preferably in a range of about 2 kg/min to about 20 kg/min for example about 5 kg/min to about 15 kg/min. A lower flow rate allows a more controlled application of the solid particulates 12 to the substrate 60.

In addition to the solid particulates 12, fluff (not shown) optionally can be conveyed through the inner conduit 210 for deposition onto the substrate 60. The fluff helps to create the particulate-substrate composite 50 such that a deposited particulate layer 74 has an entangled structure with good capillary properties, thereby increasing the absorption efficiency of the composite 50. Specifically, the fluff helps transport liquid material (e.g., urine waste in a diaper) via capillary action away from the top surface 76 of the composite 50 into the composite 50 interior, where the liquid material can be absorbed by the solid particulates 12 (e.g., when they include SAP particles). This capillary action tends to increase the absorption efficiency of the composite 50. Specifically, the absence of fluff can result in the surface 76 of the composite 50 becoming rapidly saturated with absorbed liquids, thereby forming a crust inhibiting the absorption of further liquids. Such an effect reduces the ability of sub-surface solid particulates 12 to absorb liquids, and it can also undesirably result in the leakage of liquids and/or the retention of liquids in contact with a wearer's skin (e.g., when the composite 50 is incorporated into an absorbent article). The transport capability of the fluff helps to keep liquids away from a wearer's skin, helps to prevent to saturation of the surface solid particulates 12, and facilitates the absorption of liquids by sub-surface solid particulates 12.

Fluff includes both natural material such as cellulosic fibers and synthetic materials such as polymeric fibers. Suitable polymeric fibers include polyolefins (e.g., polypropylenes), rayons, and polyesters, and are available from Freudenberg Nonwovens (Charlotte, N.C.), PGI Nonwovens (Charlotte, N.C.), and Rayonier, Inc. (Jessup, Ga.). Cellulosic fibers can include, but are not limited to, chemical wood pulps such as sulfite and sulfate (sometimes called Kraft) pulps, as well as mechanical pulps such as ground wood, thermomechanical pulp and chemithermomechanical pulp. More particularly, the pulp fibers may include cotton, other typical wood pulps, cellulose acetate, debonded chemical wood pulp, and combinations thereof Pulps derived from both deciduous and coniferous trees can also be used. Additionally, the cellulosic fibers may include such hydrophilic materials as natural plant fibers, milkweed floss, cotton fibers, microcrystalline cellulose, microfibrillated cellulose, polysaccharide fibers (e.g., sugar cane fibers), or any of these materials in combination with wood pulp fibers. Suitable cellulosic fluff fibers include, for example, NB480 (available from Weyerhaeuser Co., Federal Way, Wash.); NB416 (a bleached southern softwood Kraft pulp; available from Weyerhaeuser Co.); CR 54 (a bleached southern softwood Kraft pulp; available from Bowater Inc., Greenville, S.C.); SULIPHATATE HJ or RAYFLOC JLD (a chemically modified hardwood pulp; available from Rayonier Inc., Jessup, Ga.); NF 405 (a chemically treated bleached southern softwood Kraft pulp; available from Weyerhaeuser Co.); and CR 1654 (a mixed bleached southern softwood and hardwood Kraft pulp; available from Bowater Inc.).

The flow rate of fluff delivered by the two-component nozzle 200 is not particularly limited, and is generally determined according to the desired ratio between the fluff and solid particulates 12 in the final particulate-substrate composite 50 and/or downstream processing equipment limitations. The fluff flow rate is generally in a range of about 2.5 kg/min to about 25 kg/min, for example about 5 kg/min to about 15 kg/min. A lower fluff flow rate allows a more controlled application of the fluff to the substrate 60.

The solid particulates 12 and fluff are included in the particulate-substrate composite 50 in an amount such that the basis weight of the solid particulates 12 and fluff combined is generally in a range of about 400 g/m² to about 1200 g/m². The solid particulates 12 are generally included in the composite 50 in a range of about 15 wt. % to about 65 wt. %, for example about 25 wt. % to about 55 wt. %, relative to the combined weight of the solid particulates 12 and fluff included in the composite 50. Similarly, the fluff is generally included in the composite 50 in a range of about 35 wt. % to about 85 wt. %, for example about 45 wt. % to about 75 wt. %, relative to the combined weight of the solid particulates 12 and fluff included in the composite 50.

Water and/or steam (i.e., as a mist or vapor; collectively “water”) can be optionally included in the outer airflow 226 stream. The inclusion of water can reduce the accumulation of electrostatic charges on the solid particulates 12 and the fluff, and water can further facilitate the attachment of binders to the solid particulates 12. Because hot water is generally absorbed by SAP particles more rapidly than cold water, steam is preferably used when there is a limited contact distance between the two-component nozzle 200 and the substrate 60. The accumulation of electrostatic charges is undesirable because the conveyed particulates can be unpredictably affected by electrostatic forces, resulting in particle trajectories that are different from that which otherwise would be expected based on the underlying fluid dynamics. Unpredictable particle trajectories tend to result in a less uniform application of the solid particulates 12 and fluff to the substrate 60. Similarly, the repulsive nature of the accumulated electrostatic charges tends to result in diverging particle trajectories that increase process inefficiencies due to lost solid particulates 12 and fluff that are not successfully applied to the substrate 60 during the forming step.

Water is appropriately included when the ambient environmental process conditions are sufficiently dry to promote electrostatic accumulation, for example when the ambient relative humidity is about 40% or less. When included, water is generally added at a flow rate of about 0.5% to about 15% of the combined flow rate of solid particulates 12, any optional fluff, and any optional binder. The flow rate of water can be selected independently from the flow rates of the solid particulates 12, any optional fluff, and any optional binder. Excessive water flow rates are generally undesirable because they can form a slush/slurry-type mixture with the solid particulates 12 (in particular when they represent SAP particles), which mixture can clog screens located in the forming chamber. The particular amount of water is generally selected as the minimum amount effective for reducing and/or eliminating electrostatic accumulation, although a larger amount of water can be used to affect the impact properties of discharged solids onto the substrate 60 (as described below).

A binder can be optionally included in the inner and/or outer airflow 216, 226 streams. Any included binder can attach to the outer surfaces of the solid particulates 12 (e.g., upon entering the free stream region 234), which facilitates the attachment of the solid particulates 12 to each other and to the fluff in the particle-substrate composite 50. The binder can be in the form of solid binder particles generally having particle sizes ranging from about 10 μm to about 30 μm for example from about 15 μm to about 25 μm. The binder can also be in the form of liquid binder droplets, for example when the binder is naturally a liquid at ambient conditions or when the binder is dissolved in a carrier solvent Liquid binder droplets generally have particle sizes ranging from about 5 μm to about 30 μm, for example from about 10 μm to about 25 μm. Solid binders can be included in either the inner and/or outer airflows 216, 226, while liquid binders are preferably included in the outer airflow 226. The particular type of binder used is not particularly limited, and suitable binders include natural organic binders (for example, starch and other polysaccharides), water-based adhesives, and hot-melt adhesives. A suitable polysaccharide-based binder is available from Lysac Technologies, Inc. (Boucherville, Canada).

When included, the solid binder is generally added at a flow rate of about 0.005% to about 40% of the flow rate of solid particulates 12. Similarly, the liquid binder is generally added at a flow rate of about 0.005% to about 60% of the flow rate of solid particulates 12. The flow rate of binder can be selected independently from the flow rates of the solid particulates 12. The particular amount of binder used is selected such that each of the solid particulates 12 issuing from the two-component nozzle 200 ideally has at least some binder coated to its outer surface prior to being deposited on the substrate 60. In practice, however, up to about 20% (by number; for example up to about 10%) of the solid particulates 12 can be free of binder. Binder-free solid particulates 12 can still be successfully deposited onto the substrate 60, due to the likelihood of being deposited adjacent to solid particulates 12 that have been successfully coated with the binder. For those solid particulates 12 that are coated with binder, about 5% to about 80% (for example about 30%) of the surface area of each individual solid particulate 12 is coated. The fluff material, because of its self-entangling fibrous structure, need not be coated with binder to form an at least loosely coherent structure. Thus, a binder flow rate that results in the desired degree of coverage for the solid particulates 12 (i.e., with respect the number fraction of solid particulates 12 that are coated and the surface area fraction of each solid particulate 12 that is coated with binder) is sufficient to result in the components of a deposited particulate layer 74 being suitably adhered to each other in the particulate-substrate composite 50.

### Process for Applying Solid Particulates to a Substrate

The disclosed two-component nozzle 200 can be used in a process for the homogeneous application of the solid particulates 12 to the substrate 60. In the process, the solid particulates 12 are pneumatically fed via the inner airflow 216 to the inner flow region 214 of the two-component nozzle 200 and the outer airflow 226 is supplied to the outer flow region 224 using suitable air delivery and solids delivery means known in the art. As described above, fluff optionally can be pneumatically fed via the inner flow airflow 216 as well. Also as described above, water and/or binder optionally can be supplied by the two-component nozzle 200.

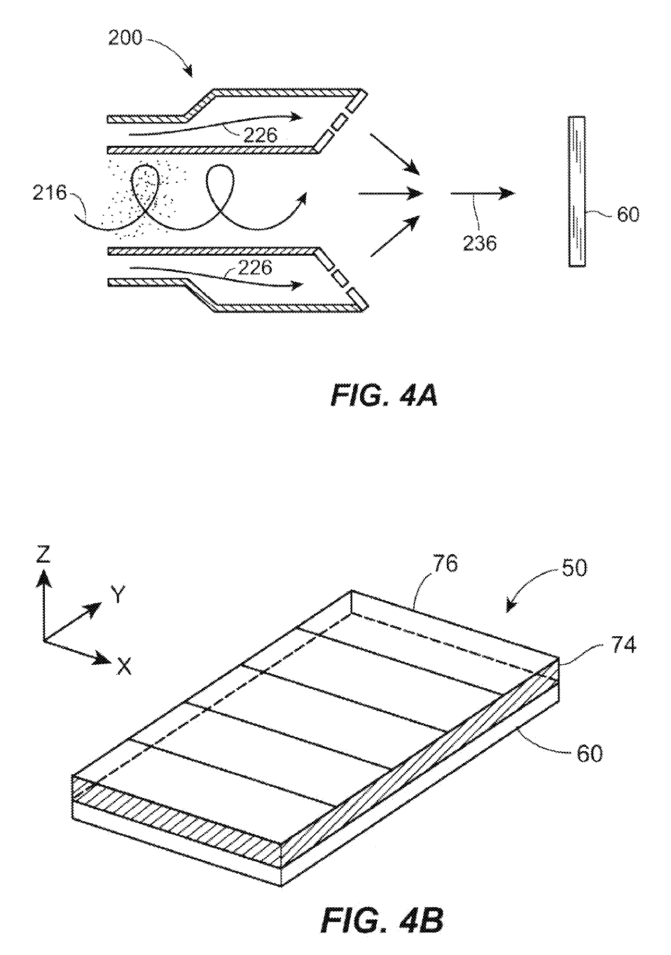

Once the inner and outer airflows 216, 226 exit the two-component nozzle 200, the streams mix in the free stream region 234 to form a mixed particulate stream 236, as illustrated in FIG. 4A. The mixed particulate stream 236 includes the solid particulates 12 in addition to any of the optional water, binder, and fluff that were fed to the two-component nozzle 200. While the solids being conveyed in the inner conduit 210 are expected to be maldistributed across the exit plane B-B′ in the same manner as illustrated in FIG. 1B, the converging nature of the outer airflow 226 serves to redistribute any conveyed solids in a more uniform manner at a predetermined distance L downstream from the exit plane B-B′. FIG. 2B illustrates a downstream particulate distribution 230 uniformly distributed across a downstream plane D-D′, in which a line 232 represents the downstream projected edge of the inner wall 212 for reference. At the downstream distance L, there has been sufficient time for the mixed particulate stream 236 to uniformly redistribute the solid particulates 12 (and any optional components) across the downstream plane D-D′. Accordingly, the substrate 60 should be located at least a distance L away from the two-component nozzle 200 in order to obtain a uniform, homogeneous application of the solid particulates 12 and optional fluff to the substrate 60, thereby forming the uniformly deposited particulate layer 74 illustrated in FIG. 4B. Generally, the two-component nozzle 200 and substrate 60 can be separated by distances from about 2.5 cm to about 3 m, for example about 10 cm to about 3 m.

The velocities of the inner airflow 216, the outer airflow 226, and the mixed particulate stream 236 are selected to provide fluid dynamic control over the distribution and deposition of the solid particulates 12 and optional fluff In an embodiment, the velocities are selected to provide laminar flow streams. The velocities of the inner airflow 216 and the outer airflow 226 can be independently controlled by air pressure regulators and/or valves (not shown).

The velocity of the mixed particulate stream 236 is advantageously selected to promote the deposition of the solid particulates 12 and optional fluff onto the top of the substrate 60. If the velocity is excessive and there is little or no water and/or binder to increase the mass of the solid particulates 12 and optional fluff, some solids are reflected away from the substrate 60 surface. These random reflections can result either in a loss of solids (because some reflected solids are not retained on the substrate 60) or a maldistribution of solids (because some reflected solids are re-deposited on the substrate 60 in a location different that what was intended). If the velocity is excessive and there is a substantial amount of water and/or binder to increase the mass of the solids, some solids have sufficient inertia to penetrate the substrate 60 (for example, when the substrate 60 is a nonwoven fibrous web) and become deposited on the bottom of the substrate 60. If either of these two phenomena is observed, the velocity of the mixed particulate stream 236 can be reduced. Alternatively or additionally, the water and/or binder content of the mixed particulate stream 236 can be increased (to prevent reflection of the solids) or decreased (to prevent penetration of the solids).

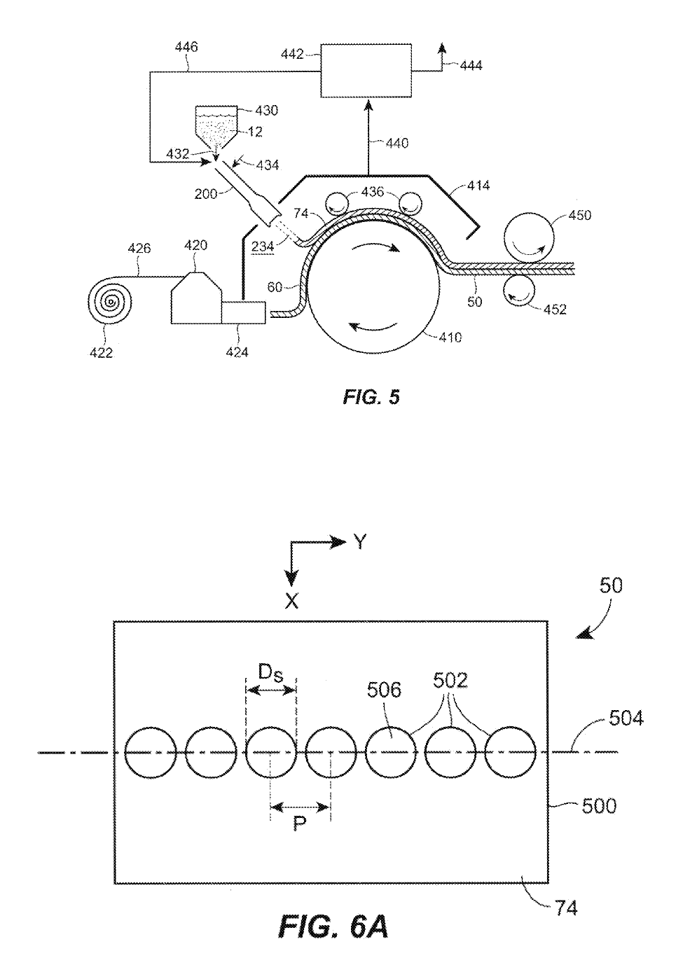

An example production process for the homogeneous application of the solid particulates 12 and any optional fluff to the substrate 60 is illustrated in FIG. 5. The forming process generally includes a rotating vacuum forming drum 410 partially encased by a forming chamber 414. In an alternate embodiment (not shown), the forming drum 410 can be replaced by a horizontal endless belt.

A virgin fluff roll 422 feeds a continuous sheet of virgin fluff 426 to a hammer mill 420. The virgin fluff 426 can be formed from the same materials described above for the fluff material that is optionally fed to the two-component nozzle 200. However, the virgin fluff 426 and the optional fluff in the two-component nozzle 200 need not be formed from the same materials in a single application. The virgin fluff 426 is preferably formed from polymeric fibers. The continuous sheet of virgin fluff 426 is fiberized into shorter, discontinuous fibers by the hammer mill 420. The fiberized virgin fluff 426 is then fed via a hammer mill applicator 424 into the forming chamber 414. The hammer mill applicator 424 can be the conducting pipe/nozzle 100 described above.

The fiberized virgin fluff 426 entering the forming chamber 414 is applied to the outer surface of the rotating vacuum forming drum 410. The rotation and vacuum of the forming drum 410 results in a continuous layer of fiberized virgin fluff 426 on the outer surface of the forming drum 410, thereby forming the substrate 60 and further conveying the substrate 60 through the forming chamber 414.

The two-component nozzle 200 is situated such that its exit is located in the forming chamber 414 and directed toward the forming drum 410. The two-component nozzle 200 is fed by a feed hopper 430 containing a fresh charge of solid particulates 12. A metering device (not shown) delivers the desired amount of solid particulates 12 in a solids feed stream 432 to the inner flow region 214 of the two-component nozzle 200. An air feed stream 434 is delivered to the outer flow region 224 of the two-component nozzle 200, thereby providing the outer airflow 226. If optional components (e.g., fluff, water, binders) are delivered by the two-component nozzle 200, additional feeding means (not shown) can be included in the process. The solid particulates 12 and any optional components delivered by the two-component nozzle 200 enter the forming chamber 414 in the free stream region 234 and are then deposited as the particulate layer 74 on the substrate 60, thereby forming the particle-substrate composite 50.

As the particle-substrate composite 50 is conveyed through the forming chamber 414 by the forming drum 410, scarfing rolls 436 optionally can be used to remove and recycle excess material from the particulate layer 74. The scarfing rolls 436 can improve the weight distribution deviation of the composite 50 by removing material from the particulate layer 74 in regions of the composite 50 having locally high deposition amounts. However, the scarfing rolls 436 are ineffective for improving the weight distribution deviation in regions of the composite 50 having locally low deposition amounts (i.e., below the level of the scarfing rolls). The two-component nozzle 200 is capable of applying the solid particulates 12 to the substrate 60 in a manner that reduces the weight distribution deviation of the composite 50 (e.g., less than about 15%, as described in more detail below) without using the scarfing rolls 436. Accordingly, the scarfing rolls 436 can be omitted from the production process.

When the particle-substrate composite 50 exits the forming chamber 414, it is removed from the forming drum 410 via a vacuum transfer drum 450. The composite 50 is then conveyed downstream via transfer drums 450, 452 for further processing steps (not shown), such as cutting, application of other absorbent article components (e.g., films, adhesives, elastics, nonwovens), and packaging of a final absorbent article product (e.g., diaper or a feminine hygiene product).

In the illustrated embodiment of FIG. 5, a vacuum is drawn within the forming chamber 414 via a rotary dust collecting system 442. The vacuum creates a total airflow of about 7000 scfm to about 16000 scfm cycling through the forming chamber 414 and being distributed among the two-component nozzle 200 and the hammer mill applicator 424. A forming chamber exhaust 440 removes dust and other solids (including, e.g., fiberized virgin fluff 426, solid particulates 12, optional fluff and/or binder delivered by the two-component nozzle 200) that is airborne in the headspace of the forming chamber 414 and delivers the dust and other solids to the rotary dust collecting system 442. The rotary dust collecting system 442 uses rotary filters (not shown) to expel waste (e.g., dust) from the process via a process exhaust 444. Non-waste (e.g., fiberized virgin fluff 426, solid particulates 12, optional fluff and/or binder) is recycled by the rotary dust collecting system 442 via a process recycle 446. In an embodiment (not shown), the process recycle 446 can be fed directly into the forming chamber 414. However, in the illustrated embodiment, the process recycle 446 is combined with the solids feed stream 432 and the two are then delivered by the two-component nozzle to the forming chamber 414. This combination of streams has the advantage of providing an increased flow residence time over which the recycled and fresh feed material are pre-blended prior to entering the forming chamber, thereby increasing the homogeneity of the final particle-substrate composite 50.

### Effects of the Two-Component Nozzle

The uniformly deposited particulate layer 74 illustrated in FIG. 4B permits the formation of the particulate-substrate composite 50 having a reduced weight distribution deviation of solid material (e.g., solid particulates 12 and optional fluff). The weight distribution deviation represents the local deviation from the desired mean application amount of solid material in the cross- and machine-directions (i.e., the x- and y-directions, respectively, as illustrated in FIG. 4B). For example, it may be desired to globally apply a mean amount of 500 g/m² of solid material to the substrate 60, but the solid material amount might vary locally from amounts as low as 300 g/m² to as high as 700 g/m². In such a case, the weight distribution deviation could be unacceptably high. However, the two-component nozzle 200 can reduce such undesirable non-uniformity and is capable of applying the solid particulates 12 (and any optional fluff) to the substrate 60 such that the deposited solid material (or the formed particulate-substrate composite 50) has a weight distribution deviation, when measured as a linear deviation (i.e., in the machine-direction) or when measured as an areal deviation (i.e., in both the machine- and cross-directions), of about 15% or less, about 10% or less, or about 7% or less, for example about 5% or less. Methods of determining the property are described in more detail below.

It is advantageous to obtain the particulate-substrate composite 50 having the uniformly deposited particulate layer 74 illustrated in FIG. 4B instead of the non-uniformly deposited particulate layer 70 illustrated in FIG. 1C. When the deposited particulate layer 70 is non-uniformly distributed, there can be insufficient solid particulates 12 to absorb all fluids discharged in a low solids density region 78. In such a case, an absorbent article made from the particulate-substrate composite 50 can be undesirably likely to leak. The inclusion of fluff does not remedy this tendency to leak. Specifically, while the fluff enhances the capillary properties of the particulate-substrate composite 50 by transporting fluids away from the discharge surface 76, the relative lack of solid particulates 12 in the low solids density region 78 means that the transported fluids have no absorbent destination and can nonetheless leak as well, because saturated fluff has no remaining capillary capacity to transport excess fluids to another zone in the particulate-substrate composite 50. In contrast, when the deposited particulate layer 74 is more uniformly distributed, every location in an absorbent article preferably has sufficient solid particulates 12 to absorb discharged fluids and sufficient fluff to increase the absorption efficiency of the particulate-substrate composite 50 due to the resulting constant capillary action. Specifically, because transported fluids have an absorbent destination, the fluff is generally less likely to become saturated during normal use.

### Methods for the Determination of the Weight Distribution Deviation

The weight distribution deviation of the solid particles 12 and fluff in the particulate-substrate composite 50 can be measured in either or both of the machine direction (i.e., a linear weight distribution deviation along the length (y-direction) of the composite 50) or the machine- and cross-directions (i.e., an areal weight distribution deviation along the length (y-direction) and across the width (x-direction) of the composite 50). The weight distribution deviation is defined as the relative standard deviation of local basis weight measurements taken from the composite 50.

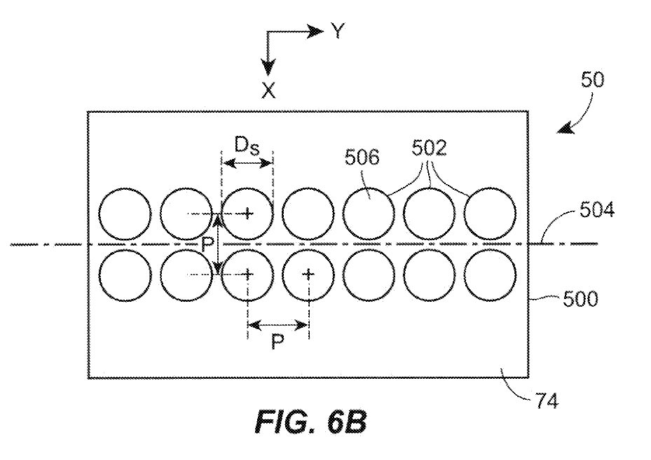

The application of both methods is illustrated in FIGS. 6A and 6B. Regardless of which of the two methods is used to determine the weight distribution deviation, a sample 500 of the particulate-substrate composite 50 is cut to a sample size of about 225 mm (the width or cross direction)×600 mm (the length or machine direction). The sample 500 can be cut from a continuous sheet (i.e., such as might be available from a production process), or it can be cut from an existing absorbent article (e.g., a diaper or a feminine hygiene product).

As shown in FIG. 6A, when measuring the linear weight distribution deviation, a total of seven sub-samples 502 are taken from the sample 500 along the sample centerline 504 (i.e., the line in the machine-direction dividing the sample into two approximately equal halves). Each sub-sample 502 has a cross-sectional area 506 of about 20 cm², and is in the shape of a circle with a diameter D_{S} of about 5.05 cm. The sub-samples 502 are arranged with a pitch P of about 6 cm, with one sub-sample 502 located in the middle of the centerline 504 and three additional sub-samples 502 located along the centerline 504 on either side. The sub-samples 502 are cut and removed from the sample 500 using a steel die (not shown) having the same cross-section as the sub-samples 502. The basis weight of each of the seven sub-samples 502 is determined by weighing each sub-sample 502 and dividing by its cross-sectional area 506. The linear weight distribution deviation is the relative standard deviation of the seven basis weight measurements (i.e., the standard deviation normalized by the mean of the measurements).

As shown in FIG. 6B, when measuring the areal weight distribution deviation, a total of fourteen sub-samples 502 are taken from the sample 500 in a 2×7 matrix (i.e., cross or x-direction×machine- or y-direction). Each sub-sample 502 has a cross-sectional area 506 of about 20 cm², and is in the shape of a circle with a diameter D_{S} of about 5.05 cm. The sub-samples 502 are arranged with a pitch P of about 6 cm on a rectangular lattice, symmetrically distributed about the sample centerline 504. The sub-samples 502 are cut and removed from the sample 502 using a steel die (not shown) having the same cross-section as the sub-samples 502. The basis weight of each of the seven sub-samples 502 is determined by weighing each sub-sample 502 and dividing by its cross-sectional area 506. The areal weight distribution deviation is the relative standard deviation of the fourteen basis weight measurements (i.e., the standard deviation normalized by the mean of the measurements).

If the size of the available particulate-substrate composite 50 limits the dimensions of the sample 500, the sample length and/or width can be reduced accordingly to the maximum available dimensions. If the resulting sample size is insufficient to take sub-samples 502 having cross-sectional areas 506 of about 20 cm², the cross-sectional area 506 can be reduced to the extent necessary such that a total of seven or fourteen sub-samples 502 are measured (i.e., according to the particular weight distribution deviation). If the cross-sectional area 506 is so reduced, then it is reduced such that pitch P of the sub-sample 502 arrangement is about 20% larger than the diameter D_{S} of the sub-sample 502.

The foregoing description is given for clearness of understanding only, and no unnecessary limitations should be understood therefrom as modifications within the scope of the invention may be apparent to those having ordinary skill in the art,

Throughout the specification, where the composition is described as including components or materials, it is contemplated that the compositions can also consist essentially of, or consist of, any combination of the recited components or materials, unless described otherwise. Combinations of components are contemplated to include homogeneous and/or heterogeneous mixtures, as would be understood by a person of ordinary skill in the art in view of the foregoing disclosure.

What is claimed is:

1. A two-component nozzle for the pneumatic delivery of solid particulates, comprising:
an inner conduit comprising an inner wall, an inner exit plane defined by the inner wall, and an inner flow region defined as the space encompassed by the inner wall;
an outer conduit surrounding the inner conduit, the outer conduit comprising an outer wall, an outer exit plane defined by the outer wall, and an outer flow region defined as the space between the inner wall and the outer wall; and,
a foraminous plate comprising an inner edge, an outer edge, and a plurality of orifices, wherein the outer edge is attached to the outer wall at the outer exit plane and the inner edge is attached to the inner wall at the inner exit plane;
wherein the two-component nozzle is capable of applying solid particulates exiting the inner flow region to a substrate such that the solid particulates have a linear weight distribution deviation of less than about 15%.

2. The two-component nozzle of claim 1, wherein the linear weight distribution deviation is less than about 10%.

3. The two-component nozzle of claim 1, wherein the linear weight distribution deviation is less than about 5%.

4. The two-component nozzle of claim 1, wherein the two-component nozzle is capable of applying solid particulates exiting the inner flow region to a substrate such that the solid particulates have an areal weight distribution deviation of less than about 15%.

5. The two-component nozzle of claim 4, wherein the areal weight distribution deviation is less than about 10%.

6. The two-component nozzle of claim 4, wherein the areal weight distribution deviation is less than about 5%.

7. The two-component nozzle of claim 1, wherein the solid particulates comprise superabsorbent polymer particles.

8. The two-component nozzle of claim 7, wherein the superabsorbent polymer particles comprise granules.

9. The two-component nozzle of claim 7, wherein the superabsorbent polymer particles comprise at least one of fibers, flakes, and droplet-shaped particles.

10. The two-component nozzle of claim 1, wherein:
the inner conduit has a circular cross section with an inner diameter;
the outer conduit has a circular cross section with an outer diameter;
the outer diameter is larger than inner diameter; and,
the inner conduit and the outer conduit are aligned such that the outer flow region has a substantially annular cross section.

11. The two-component nozzle of claim 1, wherein the outer conduit completely surrounds the inner conduit.

12. The two-component nozzle of claim 1, comprising a plurality of outer conduits partially surrounding the inner conduit, wherein the outer conduits are circumferentially distributed around the inner conduit.

13. The two-component nozzle of claim 1, wherein the orifices have a cylindrical shape.

14. The two-component nozzle of claim 1, wherein the orifices have a frustoconical shape expanding in a direction generally from the inner exit plane to the outer exit plane.

15. The two-component nozzle of claim 1, wherein the orifices have a diameter in a range of about 1 mm to about 5 mm.

16. The two-component nozzle of claim 1, wherein the orifices have a diameter in a range of about 2 mm to about 4 mm.

17. The two-component nozzle of claim 1, wherein the plurality of orifices has a surface area relative to the surface area between the outer edge and the inner edge of the foraminous plate in a range of about 0.01 to about 0.1.

18. The two-component nozzle of claim 1, wherein the plurality of orifices has a surface area relative to the surface area between the outer edge and the inner edge of the foraminous plate in a range of about 0.02 to about 0.05.

19. The two-component nozzle of claim 1, wherein the foraminous plate and the outer wall define a contact angle, the contact angle being less than 90°.

20. The two-component nozzle of claim 1, wherein the foraminous plate and the outer wall define a contact angle, the contact angle being in a range of about 5° to about 75°.

21. The two-component nozzle of claim 1, wherein the foraminous plate and the outer wall define a contact angle, the contact angle being in a range of about 30° to about 70°.

22. The two-component nozzle of claim 1, wherein:
the foraminous plate and the outer wall define a contact angle;
each orifice has an axis defining an orifice angle with the foraminous plate; and,
the sum of the contact angle and the orifice angle is less than 180°.

23. The two-component nozzle of claim 1, wherein:
the foraminous plate and the outer wall define a contact angle;
each orifice has an axis defining an orifice angle with the foraminous plate; and,
the sum of the contact angle and the orifice angle is in a range of about 95° to about 165°.

24. The two-component nozzle of claim 1, wherein:
the foraminous plate and the outer wall define a contact angle;
each orifice has an axis defining an orifice angle with the foraminous plate; and,
the sum of the contact angle and the orifice angle is in a range of about 120° to about 160°.

25. A two-component nozzle for the pneumatic delivery of solid particulates, comprising:
an inner conduit comprising an inner wall, an inner exit plane defined by the inner wall, and an inner flow region defined as the space encompassed by the inner wall;
an outer conduit surrounding the inner conduit, the outer conduit comprising an outer wall, an outer exit plane defined by the outer wall, and an outer flow region defined as the space between the inner wall and the outer wall; and,
a foraminous plate comprising an inner edge, an outer edge, and a plurality of orifices, wherein the outer edge is attached to the outer wall at the outer exit plane and the inner edge is attached to the inner wall at the inner exit plane;
wherein:
the foraminous plate and the outer wall define a contact angle;
each orifice has an axis defining an orifice angle with the foraminous plate;
the contact angle is less than 90°; and,
the sum of the contact angle and the orifice angle is less than 180°.

26. A process for the homogeneous application of solid particulates to a substrate, comprising the steps of:
(a) providing a two-component nozzle comprising:
an inner conduit comprising an inner wall, an inner exit plane defined by the inner wall, and an inner flow region defined as the space encompassed by the inner wall;
an outer conduit surrounding the inner conduit, the outer conduit comprising an outer wall, an outer exit plane defined by the outer wall, and an outer flow region defined as the space between the inner wall and the outer wall; and,
a foraminous plate comprising an inner edge, an outer edge, and a plurality of orifices, wherein the outer edge is attached to the outer wall at the outer exit plane, the inner edge is attached to the inner wall at the inner exit plane, and the foraminous plate and the outer exit plane define a contact angle less than 90°;
(b) pneumatically feeding solid particulates to the inner flow region;
(c) supplying an airflow to the outer flow region;
(d) mixing the solid particulates exiting the two-component nozzle from the inner flow region with the airflow exiting the two-component nozzle from the outer flow region, thereby forming a mixed particulate stream; and,
(e) applying the mixed particulate stream to a substrate, thereby forming a particulate-substrate composite material.

27. The process of claim 26, wherein the particulate-substrate composite material has a linear weight distribution deviation of less than about 15%.

28. The process of claim 26, wherein the particulate-substrate composite material has an areal weight distribution deviation of less than about 15%.

29. The process of claim 26, wherein the solid particulates comprise superabsorbent polymer particles.

30. The process of claim 26, wherein the step of pneumatically feeding solid particulates also includes pneumatically feeding fluff to the inner flow region.

31. The process of claim 26, wherein the step of pneumatically feeding solid particulates also includes pneumatically feeding a solid binder to the inner flow region.

32. The process of claim 26, wherein the step of pneumatically feeding solid particulates comprises feeding fresh solid particulates and recycled solid particulates to the inner flow region.

33. The process of claim 26, wherein the step of supplying an airflow also includes supplying water to the outer flow region.

34. The process of claim 26, wherein the step of supplying an airflow also includes supplying a binder to the outer flow region.

35. An absorbent article formed according to the process of claim 26.
